(19) United States
(12) Patent Application Publication
(10) Pub. No.: US 2008/0258121 A1
(43) Pub. Date: Oct. 23, 2008

(54) Fire Retardant Composition

(76) Inventor: Hasan Farooq, Woodbridge (CA)

Correspondence Address: HODGSON RUSS LLP;THE GUARANTY BUILDING, 140 PEARL STREET, SUITE 100, BUFFALO, NY, 14202-4040, US

(21) Appl. No.: 11/738,662

(22) Filed: Apr. 23, 2007

(51) Int. Cl. C09K 21/02

(52) U.S. Cl. 252/601

(57) ABSTRACT

A composition used for fire retardance, comprising water, camphor and ammonium chloride is disclosed.

### FIELD OF INVENTION

This invention relates to the use of a mixture of chemicals to make a fire retardant composition which can be applied to various surfaces to prevent or slow down fires.

### BACKGROUND

The processes of making fire retardant compositions including soluble salts such as ammonium compounds, is well known. The chemicals are usually chosen based on the fact that they have the chemical function of preventing each other from burning. However, depending on the chemicals used, the product produced may not be cost effective, they may be difficult to apply, and they may not be suitable for all surfaces.

Ammonium chloride is odorless white powder being stable under ordinary conditions of use and temperature. It is prepared commercially by reacting ammonia, NH₃, with hydrogen chloride, HCl:

NH₃+HCl→NH₄Cl

At temperatures associated with combustion, ammonium chloride begins to corrode metals and may dissociate into ammonia and hydrogen chloride. Mixtures of about 16% to 25% (by volume) ammonia gas in air are flammable. So the use of ammonium chloride in a fire retardance role is not known, nor would such use be expected to be desirable.

It is an object of the present invention to provide a novel fire retardant composition that is easy to apply, environmentally friendly, cost effective, and may be easily manufactured.

### SUMMARY OF THE INVENTION

In accordance with an aspect of this invention, there is provided a flame retardant composition comprising ammonium chloride, camphor and water. In a particular embodiment, ammonium chloride and water are mixed at below the solution's boiling temperatures and solid camphor is subsequently added. In a further embodiment, liquid camphor is added to ammonium chloride and then added to water.

### DETAILED DESCRIPTION

The novel fire retardant composition of this invention comprises a mixture of ammonium chloride, camphor and water. To ensure safety of the fire retardant solution before application it is imperative to ensure that it is produced using consistent temperatures and solution contents. An example of how to produce this composition is as follows:

(i) introduce an amount of water at a temperature below boiling the boiling point and mix in ammonium chloride to approximately 20-25% by weight into the solution until completely dissolved. Note that the solubility is 29.7 grams per 100 g of water at 0 degrees C. Although functionality of the solution was observed at this percentage range, it would be expected that functionality would occur at lower percentage by weight composition of ammonium chloride, such as 10% by weight ammonium chloride. Then, once ammonium chloride is completely dissolved in the water, add to this solution 5-10% by weight camphor preferably in solid form, namely tablet/block form. As will be discussed below, camphor oil may also be utilized.

In one preferred solution of the invention, 1 liter of water at 25 degrees Celsius was combined with 42 grams of ammonium chloride. 42 grams of camphor in solid form (6 tablets of 7 grams each) were added to the solution. To ensure the minimum solution for functionality, the solution is preferably left to react for at least 4 hours, ensuring at all times that solution stays below the boiling temperature. Solutions left to react for at least 4 hours, displayed significant flame retardance during testing. After 4 hours a small portion of camphor dissolved. After leaving the solution for 48 hours, 11 grams of camphor dissolved into the solution, the temperature of the solution then measured at 20 degrees Celsius. After excess camphor was removed, the solution was tested after 4 and 48 hours of reaction time and achieved significant flame retardance (see below).

Avoiding solution boiling temperature is important because the use and function of camphor disappears in the air when it's heated to a certain degree. Once through the reaction process, it is recommended to test the final product to make sure its functioning properly.

In one embodiment of the invention, the composition comprises nitrogen propellant to allow delivery of said composition in aerosol form.

In a further embodiment, camphor oil (pure camphor in liquid form) was used in place of solid camphor. In this embodiment, 6 drops (approximately 5 ml) of camphor oil was added to approximately 4 grams of ammonium chloride and mixed with 100 ml of water. The preferred minimum time to achieve functionality was to allow reaction for at least 4 hours, however better functionality was observed at 8 hours.

### Experimentation

Experiments were conducted by spraying, dipping, mixing and brushing or otherwise applying a compound comprising (1 liter of water, with ammonium chloride (42 grams), camphor 11 grams dissolved into the solution) on various products including clothing, drywall, wood, paper/cardboard and paint. The results are set out as follows:

Clothing: The composition was applied to different clothing materials as follows:
1. 20% polyester and 80% cotton
2. 100% cotton
3. 50% cotton, 38% polyester and 2% spandex

For control purposes, each clothing material was placed in said open flame for (15 seconds) without application of the composition. Without the presence of the composition, each clothing material combusted and completely disintegrated within the time period.

The composition was applied to the entirety of each of the above clothing materials. Such materials were place within an open flame for (15 seconds). Clothing to which the composition was applied did not ignite when exposed to said flame. Only a slight blackening at the point of flame contact was experienced. Application of the compound to these clothing materials did not cause any degradation or deterioration thereto.

Likewise application of the compound to drywall did not cause any deterioration, discoloration to drywall, paper and cardboard and tissue paper, wood, including maple, pine and other unknown wood, paints (oil and water based paints). When the above items, were placed in open flames for (60 seconds) without the composition applied to the external surface thereof, they were combusted and destroyed by the flame. The composition was applied to the surface of each of the above and when a flame was applied at the point of composition application, there was no fire damage or combustion of these products after 30 seconds.

Note the above experiment was conducted using a solution that reacted for 4 hours and 48 hours, both achieving enough flame retardance to avoid ignition.

### Experiment II

The same experiment was conducted using a solution formed of 100 ml water, 40 grams of ammonium chloride and 10 ml of camphor oil. The ammonium chloride and camphor oil were mixed together and then added to water at 25 degrees Celsius and allowed to react for 8 hours. The same results were observed in respect of flame retardance. Similar results would be expected for a solution left to react for 4 hours.

While the invention has been described according to what are presently considered to be the most practical and preferred embodiments, it must be understood that the invention is not limited to the disclosed embodiments. Those ordinarily skilled in the art will understand that various modifications and equivalent structures and functions may be made without departing from the spirit and scope of the invention. Therefore, the invention must be accorded the broadest possible interpretation so as to encompass all such modifications and equivalent structures and functions. Furthermore, the invention should be understood to be limited by the claims appended hereto, purposively construed.

What is claimed:

1. A fire retardant composition comprising a mixture of:
ammonium chloride;
camphor; and
water.

2. The fire retardant composition according to claim 1 wherein comprising 20-25% by weight ammonium chloride, and 5-10% by weight camphor.

3. The composition of claim 1 further comprising nitrogen propellant to allow delivery of said composition in aerosol form.

4. The composition as recited in claim 1 wherein comprising approximately 42 grams ammonium chloride and 11 grams camphor per liter of water.

5. The composition as recited in claim 1 wherein camphor in liquid form is added to powdered ammonium chloride and then both added to water.

6. The composition as recited in claim 1 wherein 50 ml of liquid camphor and 40 grams are utilized per liter of water.

7. The composition as recited in claim 1 wherein camphor and ammonium chloride powder are added to water.
